(19) United States
(12) Patent Application Publication
(10) Pub. No.: US 2006/0199619 A1
(43) Pub. Date: Sep. 7, 2006

(54) Holding arrangement for a mobile telephone and method of operating a mobile telephone held in such a manner in a vehicle

(75) Inventors: Eberhard Dammann, Baldham (DE); Hans-Juergen Winkler, Kaufering (DE); Mathias Lachmund, Schmalkalden (DE); Matthias Schmatz, Krailling (DE); Joachim Goethel, Muenchen (DE); Peter Schramm, Eching (DE); Roman Reick, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/328,092

(22) Filed: Jan. 10, 2006

Related U.S. Application Data
(63) Continuation of application No. PCT/EP04/05285, filed on May 17, 2004.

(30) Foreign Application Priority Data
Jul. 10, 2003 (DE) 103 31 412.1

(51) Int. Cl. H04M 1/00

(52) U.S. Cl. 455/569.1

(57) ABSTRACT

A holding arrangement for a mobile telephone in a vehicle is provided. The arrangement includes a base part fixedly arranged in the vehicle and a holding part detachably arranged in this base part and being detachable with respect to the latter, for the releasable accommodation of a mobile telephone. The holding part has a short-range transmission/reception device having a wire-bound electrical connection with the mobile telephone and a radio link with a corresponding other transmission/reception device arranged at a different point in the vehicle and electrically connected with the vehicle.

The present application is a continuation of PCT International Application No. PCT/EP2004/005285, filed May 17, 2004, and claims priority to German Patent Application No. DE 103 31 412.1, filed Jul. 10, 2003, the entire disclosure of these documents are herein expressly incorporated by reference.

### BACKGROUND AND SUMMARY OF THE INVENTION

The invention relates to a holding arrangement for a mobile telephone in a vehicle, having a base part fixedly arranged in the vehicle and having a holding part detachably arranged in this base part and being detachable with respect to the latter, for the releasable accommodation of a mobile telephone, as well as to a method of operating a mobile telephone held in such a manner in a vehicle.

German Patent Document DE 297 13 239 U1 discloses a two-part holding arrangement consisting of a base part and a holding part, the power supply and the data-related connection from the onboard power supply system of the vehicle to the base part and from the latter to the holding part takes place by means of multicore connection cables.

Recently, mobile telephones have also become known which are capable of establishing a short-range radio link with a control unit arranged at a different point in the vehicle and connected with respect to data with the onboard power supply system. A data-related connection with the onboard power supply system by way of the base part and the holding part is then dispensable and is also no longer be provided. If the vehicle is equipped with such a control unit, only those mobile telephones can be used in the vehicle which can establish a short-range radio link.

It is an object of the invention to create a holding arrangement of the initially mentioned type by means of which an operation of mobile telephones with a short-range radio link becomes possible even in the absence of a hardware-type data-related connection to the onboard power supply system, and to create a method by means of which an operation of mobile telephones with a short-range radio link becomes possible even when there is no hardware-type data-related connection to the onboard power supply.

This object is achieved in the case of a holding arrangement of the initially mentioned type by means of a base part fixedly arranged in the vehicle; and a holding part detachably arranged in the base part and being detachable with respect to the base part, for the releasable accommodation of a mobile telephone, wherein the holding part has a short-range transmission/reception device having a wire-bound electrical connection with the mobile telephone and a radio link with a corresponding other transmission/reception device arranged at a different point in the vehicle and electrically connected with the vehicle. The object is also achieved by means of a method of operating a mobile telephone in a vehicle in which the mobile telephone is detachably fastened in a holding part, and the holding part itself is detachably held in a base part fixedly arranged in the vehicle, the method comprising the acts of: establishing a radio link with an additional transmission and reception device in a control unit of the vehicle by way of short-range transmission/reception device, wherein the short-range transmission/reception device has a wire-bound electrical connection with the mobile telephone, and wherein the control unit is connected with a hands-free talking device inside the vehicle; and establishing a connection of the mobile telephone with a cellular telephone network.

The holding part has a short-range transmitting/receiving device having a wire-bound electrical connection with the mobile telephone and a radio link with the corresponding additional transmitting/receiving device in the control unit.

The holding arrangement constructed according to the invention therefore has the advantage that also mobile telephones can be accommodated therein which by themselves can establish no short-range radio connection with the control unit. Since the base part does not have to establish a data-related connection to the onboard power supply system, it can also be installed into the vehicle later. The holding arrangement according to the invention is therefore particularly suitable as a retrofit solution for vehicles which are not equipped with a holding arrangement for a mobile telephone in the factory.

It was found to be advantageous for the holding part of the holding arrangement according to the invention to be equipped with an antenna. The latter can be coordinated precisely with the special transmission/reception characteristics of the short-range radio link.

In addition, advantages are achieved if the holding part has a connection contact to the onboard power supply system and an electric line connected therewith and leading by way of another connection contact to the charging contact of the mobile telephone. As a result, the mobile telephone can be recharged in the held condition and remain operational for an unlimited time.

A further improvement of the invention consists of the fact that the holding part has an identification circuit for a short-range transmission/reception device present in the mobile telephone itself, and that the short-range transmission/reception device of the holding part, if required, can be blocked by the identification circuit. As a result, mobile telephones with, as well as without, a short-range radio link can be arranged in the holding arrangement. In this case, an undesirable interaction of competing transmission/reception devices is prevented.

The short-range transmission/reception device of the holding part which itself has a wire-bound electrical connection with the mobile telephone can be employed by the method according to the invention. By way of the transmission/reception device, a radio link is established with the corresponding additional transmission/reception device. The control unit is connected with a hands-free device inside the vehicle and establishes a connection for the mobile telephone with a cellular telephone network.

The method according to the invention makes it possible to also accommodate mobile telephones in the holding arrangement which by themselves can establish no short-range radio link with the control unit. Since the base part does not have to establish a data-related connection with the onboard power supply system, it can also be installed into a vehicle later. The holding arrangement according to the invention is therefore particularly suitable as a retrofit solution for vehicles which are not equipped with a holding arrangement for a mobile telephone in the factory.

It was found to be advantageous for the holding part of the holding arrangement according to the invention to be equipped with an antenna. The latter can be coordinated precisely with the special transmission/reception characteristics of the short-range radio link.

In addition, advantages are achieved if the holding part has a connection contact to the onboard power supply system and an electric line connected therewith and leading by way of another connection contact to the charging contact of the mobile telephone. As a result, the mobile telephone can be recharged in the held condition and remain operational for an unlimited time.

A further improvement of the invention consists of the fact that the holding part has an identification circuit for a short-range transmission/reception device present in the mobile telephone itself. By means of a suitable programming of the mobile telephone, it becomes possible to deactivate its short-range transmission/reception device and to activate the corresponding device of the holding part. As a result, mobile telephones with, as well as without, a short-range radio link can be arranged in the holding arrangement. In this case, an undesirable interaction of competing transmission/reception devices is prevented. In each case, the communication between the mobile telephone and the control unit in the vehicle takes place by way of the short-range transmission/reception device of the holding arrangement.

Conversely, the corresponding device of the holding part can also be deactivated. Here also, mobile telephones with, as well as without, a short-range radio link can therefore be arranged in the holding arrangement. In this case, an undesirable interaction of competing transmission/reception devices is also prevented. In this case, the communication between the mobile telephone and the control unit in the vehicle takes place by way of the short-range transmission/reception device of the mobile telephone itself.

Other objects, advantages and novel features of the present invention will become apparent from the following detailed description of the invention when considered in conjunction with the accompanying drawings.

### BRIEF DESCRIPTION OF THE DRAWING FIGURES

The invention will be further explained by means of the drawings.

FIG. 1 is a view of a device for implementing the method according to the invention, the mobile telephone being fastened in the holding part; and

FIG. 2 is a view of the device of FIG. 1 when the mobile telephone is removed from the holding part.

### DETAILED DESCRIPTION OF THE PREFERRED EMBODIMENTS

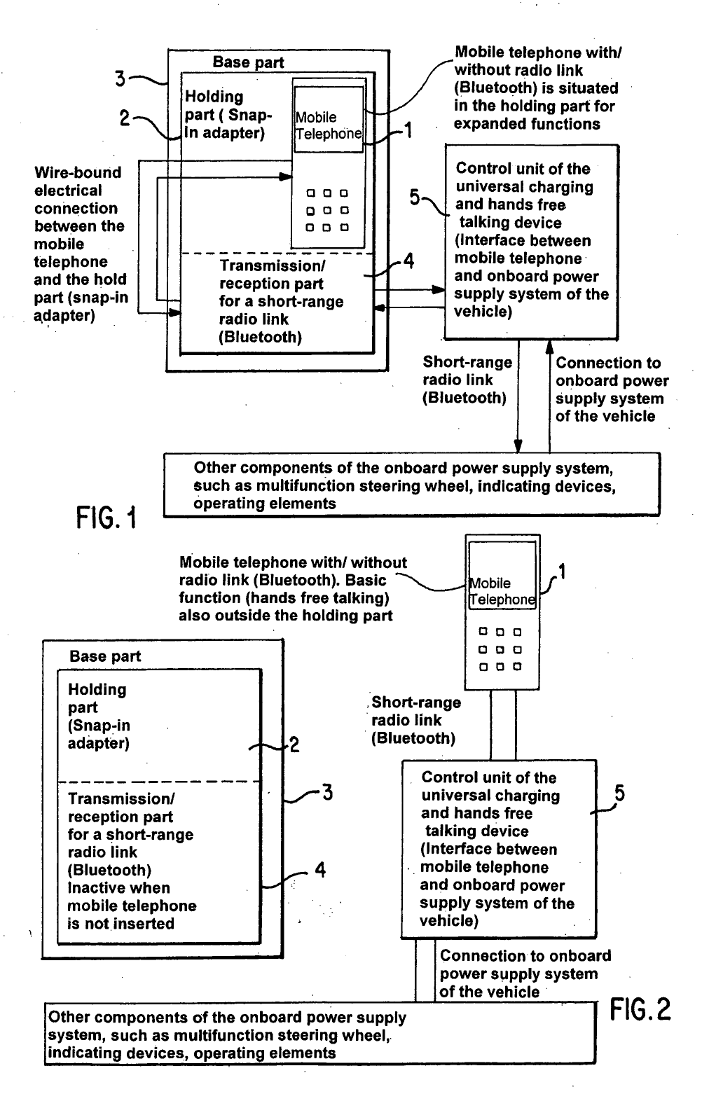

In FIG. 1 a mobile telephone 1 is detachably fastened in a holding part 2. The holding part 2 itself is detachably held in a base part 3 fixedly arranged in the vehicle. It has a short-range transmission/reception device 4 which, in turn, has a wire-bound electrical connection (also not shown) with the mobile telephone 1. As a result, a radio link with a corresponding additional transmission/reception device in a control unit 5 can be established. The control unit 5 is connected with a hands-free device (not shown) inside the vehicle, which hands-free device establishes a connection of the mobile telephone 1 with a cellular telephone network.

First, the case should be considered in which the mobile telephone 1 has no short-range radio link, such as those provided by the Bluetooth standard. Several functions can be supported by way of the short-range radio link of the transmission/reception device 4, in the following called Bluetooth interface. A laid-open standard exists for some of the functions, in the following called basic functions. This is particularly the possibility of the actual hands-free talking. According to the laid-open Bluetooth standard, the hands-free profile can be implemented by way of the Bluetooth interface between the holding part 2 and the control unit 5.

In an alternative case of a mobile telephone 1 with a short-range radio link, it is provided according to the invention to block this short-range radio link as soon as the mobile telephone 1 has been placed in the holding part 2. The transmission/reception device 4, in turn, establishes the radio link with the corresponding transmission/reception device in the control unit and, analogously to the above-described case, permits the hands-free talking by way of the Bluetooth interface between the holding part 2 and the control unit 5.

In the case of mobile telephones of certain manufacturers, it is not possible to transfer the telephone book normally present in the mobile telephone by way of the short-range transmission/reception device of the mobile telephone to the control unit. However, these data can be read out by way of the wire-bound electrical connection of the holding part 2 and can be transmitted by way of its transmission/reception device to the control unit 5.

If the telephone book is stored in the control unit 5 and is updated again during each placing of the mobile telephone 1 in the holding part 2, it becomes possible also—as illustrated in FIG. 2—when the mobile telephone 1 not inserted in the holding part, to use its telephone book and display it, for example, on the vehicle instrument panel. In this case, it is only a prerequisite that the telephone book is assigned to the mobile telephone by means of a corresponding identification. The identification can be emitted by the mobile telephone itself or by the holding part.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A holding arrangement for a mobile telephone in a vehicle, the arrangement comprising:
a base part fixedly arranged in the vehicle; and
a holding part detachably arranged in the base part and being detachable with respect to the base part, for the releasable accommodation of a mobile telephone,
wherein the holding part has a short-range transmission/reception device having a wire-bound electrical connection with the mobile telephone and a radio link with a corresponding other transmission/reception device arranged at a different point in the vehicle and electrically connected with the vehicle.

2. The holding arrangement according to claim 1, wherein the holding part includes an antenna.

3. The holding arrangement according to claim 1, wherein the holding part is coupled to an onboard power supply system of the vehicle and to a charging connection of the mobile telephone.

4. The holding arrangement according to claim 2, wherein the holding part is coupled to an onboard power supply system of the vehicle and to a charging connection of the mobile telephone.

5. A method of operating a mobile telephone in a vehicle in which the mobile telephone is detachably fastened in a holding part, and the holding part itself is detachably held in a base part fixedly arranged in the vehicle, the method comprising the acts of:
establishing a radio link with an additional transmission and reception device in a control unit of the vehicle by way of short-range transmission/reception device, wherein the short-range transmission/reception device has a wire-bound electrical connection with the mobile telephone, and wherein the control unit is connected with a hands-free talking device inside the vehicle; and
establishing a connection of the mobile telephone with a cellular telephone network.

6. The method according to claim 5, wherein the short-range transmission/reception device of the mobile telephone is blocked for a short-range transmission/reception device present in the mobile telephone itself by means of a recognition circuit present in the holding part.

7. The method according to claim 5, wherein the short-range transmission/reception device of the holding part is blocked for a short-range transmission/reception device present in the mobile telephone itself by means of a recognition circuit present in the holding part.

8. The method according to claim 5, wherein when a mobile telephone includes a short-range transmission/reception device, data which cannot be read out and transmitted by means of this transmission/reception device are read out by way of the wire-bound electrical connection of the holding part and are transmitted by way of its transmission/reception device to the control unit.

9. The method according to claim 6, wherein when a mobile telephone includes a short-range transmission/reception device, data which cannot be read out and transmitted by means of this transmission/reception device are read out by way of the wire-bound electrical connection of the holding part and are transmitted by way of its transmission/reception device to the control unit.

10. The method according to claim 7, wherein when a mobile telephone includes a short-range transmission/reception device, data which cannot be read out and transmitted by means of this transmission/reception device are read out by way of the wire-bound electrical connection of the holding part and are transmitted by way of its transmission/reception device to the control unit.
